(19) United States
(12) Patent Application Publication
(10) Pub. No.: US 2015/0131924 A1
(43) Pub. Date: May 14, 2015

(54) Creation of Rectangular Images from Input Images

(71) Applicant: Microsoft Corporation, Redmond, WA (US)

(72) Inventors: Kaiming He, Beijing (CN); Huiwen Chang, Princeton, NJ (US); Jian Sun, Beijing (CN)

(73) Assignee: Microsoft Corporation, Redmond, WA (US)

(21) Appl. No.: 14/079,310

(22) Filed: Nov. 13, 2013

(51) Int. Cl. G06T 3/00; H04N 5/232

(52) U.S. Cl. CPC G06T 3/0018; G06T 3/0093; H04N 5/23238; G06T 2210/22
USPC 382/284; 382/293

(57) ABSTRACT

Stitched images generated from combinations of multiple separate images mostly have irregular boundaries. Users generally prefer rectangular boundaries. Techniques for warping an image with irregular boundaries to give the image rectangular boundaries are disclosed herein. Preliminary warping of the image into the rectangle provides a rectangular shape on which to overlay a mesh. The image is reverted to its original shape with irregular boundaries and the mesh is warped accordingly. Global optimization is applied to the image by finding an energy minimum, or reduced energy below a threshold, for a function that gives the image a rectangular shape while preserving shapes and preserving straight lines. The mesh is warped according to the solution of the function and the image is stretched and/or compressed along with the mesh. This approach generates results that are qualitatively more visually attractive than other contemporary techniques.

### BACKGROUND

With the advance of image alignment and stitching techniques, creating panoramic images has become increasingly popular. Due to the projections (e.g., cylindrical, spherical, or perspective) that warp the source images for alignment, and also due to the camera movement while taking multiple pictures, it is almost unavoidable that the stitched images exhibit irregular boundaries. However, most people favor rectangular boundaries for publishing, sharing, and printing images. Techniques exist for “rectangling” the image or generating a rectangular image from the irregular image.

A simple rectangling technique is to crop a panoramic image to fit a rectangle. But cropping may lose desired content and reduce the impression of a wide field of view. Another solution is to synthesize missing regions between the edges of the image and a rectangular bounding box using image completion techniques that create new content which is added to the image. Some portions of an image may be suitable for image completion such as extending textures or extending simple structures like straight lines, but image completion techniques may fail at synthesizing more complex content. Cropping and image completion may be combined to address this problem, but the combination of techniques merely discards portions of the image while adding synthetic content to other portions of the image. Improved techniques for “rectangling” irregular shaped images will find broad use given the increasing amount of data created by the proliferation of digital images.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A content-aware warping algorithm generates rectangular images from stitched input images. The algorithm consists of multiple steps. A local warping operation preliminarily warps the image into a rectangle without using a mesh. This local warping operation may be implemented by use of the Seam Carving algorithm to add pixels within the image. A mesh is placed on the rectangular image and a global warping operation optimizes warping of the mesh to preserve shapes and straight lines. The mesh divides the image into a series of segments. Preservation of shapes may be implemented by solving for a function that encourages each segment to undergo a similarity transformation that includes transformation, rotation, and scaling. Preservation of straight lines may be implemented by solving for a function that quantifies line orientation for portions of lines within the segments defined by the mesh, and encouraging those portions of lines with similar orientations to be rotated to have the same rotation angle. The shape of the final image is also constrained by a function that favors a rectangular shape. Minimizing or reducing the sum of these three functions yields an output image which is rectangular, minimizes or reduces deformity of shapes within the image, and preserves straight lines in the image. Qualitative evaluation shows that his technique produces superior results compared to conventional techniques.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 shows an illustrative scenario of image generation.

FIG. 2 shows an illustrative grouping of images generated from the scenario 100 of FIG. 1.

FIG. 3 shows a target rectangle surrounding the grouping of images from FIG. 2.

FIG. 4 shows an illustrative stretched image that fills the target rectangle of FIG. 3.

FIG. 5 shows an illustrative mesh applied over the rectangular image from FIG. 4.

FIG. 6 shows an illustrative warping of the mesh from FIG. 5 when the rectangular image is returned to the original irregular shape.

FIG. 7 shows an illustrative warped image created from the image of FIG. 5 by warping the mesh of FIG. 6 into a rectangular shape using mesh-based warping.

FIG. 8 shows an illustrative process for modifying the shape of an input image to generate a rectangular image.

FIG. 9 shows an illustrative view of reducing the stretching of a rectangular image by changing the dimensions of the rectangle.

FIG. 10 shows an illustrative process for modifying the process shown in FIG. 8 by introducing a transparent region next to the image.

FIG. 11 shows the addition of a transparent region between an image with irregular boundaries and a target rectangle.

FIG. 12 shows illustrative features of the process of FIG. 8 for expanding an image to fit a rectangle.

FIG. 13 shows an illustrative technique for expanding an image to fit a rectangle.

FIG. 14 shows illustrative features of the process of FIG. 8 for creating an output mesh.

FIG. 15 shows illustrative features of the process of FIG. 14 for preserving straight lines.

FIG. 16 shows illustrative features of process FIG. 14 for iteratively calculating a weighted sum of multiple functions.

FIG. 17 shows an illustrative computing system.

### DETAILED DESCRIPTION

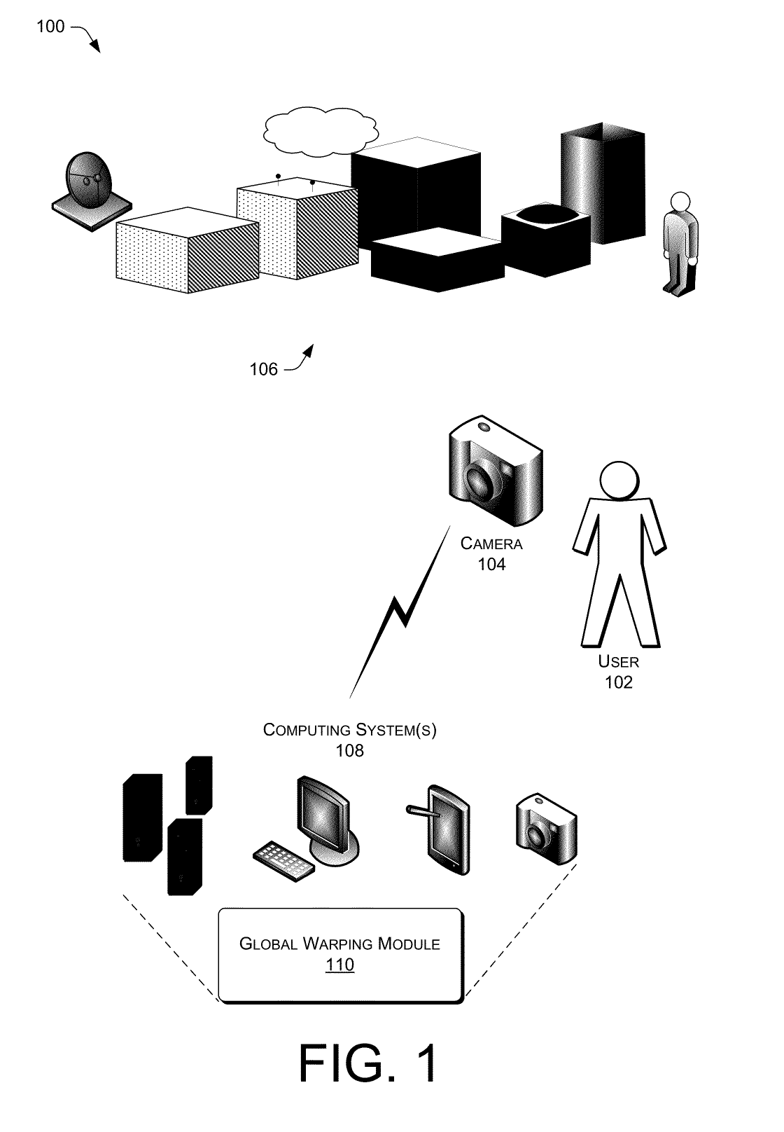

FIG. 1 shows an illustrative scenario 100 where a user 102 uses a camera 104 to take pictures of a scene 106. The scene may be a panoramic scene that is captured by the user 102 by taking multiple separate photographs. For example, the user 102 may stand in one place and alter the direction that the camera 104 is pointing to capture a series of photographs that, when viewed together, present a panoramic image of the scene 106. Each of the photographs may partially overlap and show portions of the scene 106. The photos may be created as digital files or as analog images. Still photos are just one illustrative source of images for the techniques described herein.

Images may be processed by one or more computing system(s) 108. The computing system(s) 108 may be implemented as any type of computing device such as server computers, a distributed cloud-based system, a desktop computer, a tablet computer, a notebook computer, a smart phone, a personal digital assistant, a camera (including the camera 104), other image capture device, or the like. The computing device(s) 108 may include a global warping module 110 that reshapes the collection of images captured by the camera 104 of the scene 106 into a single rectangular shaped image that preserves straight lines and minimizes or reduces distortion to shapes in the image. Both the computing device(s) 108 and the global warping module 110 are discussed in greater detail below.

### Image Preparation

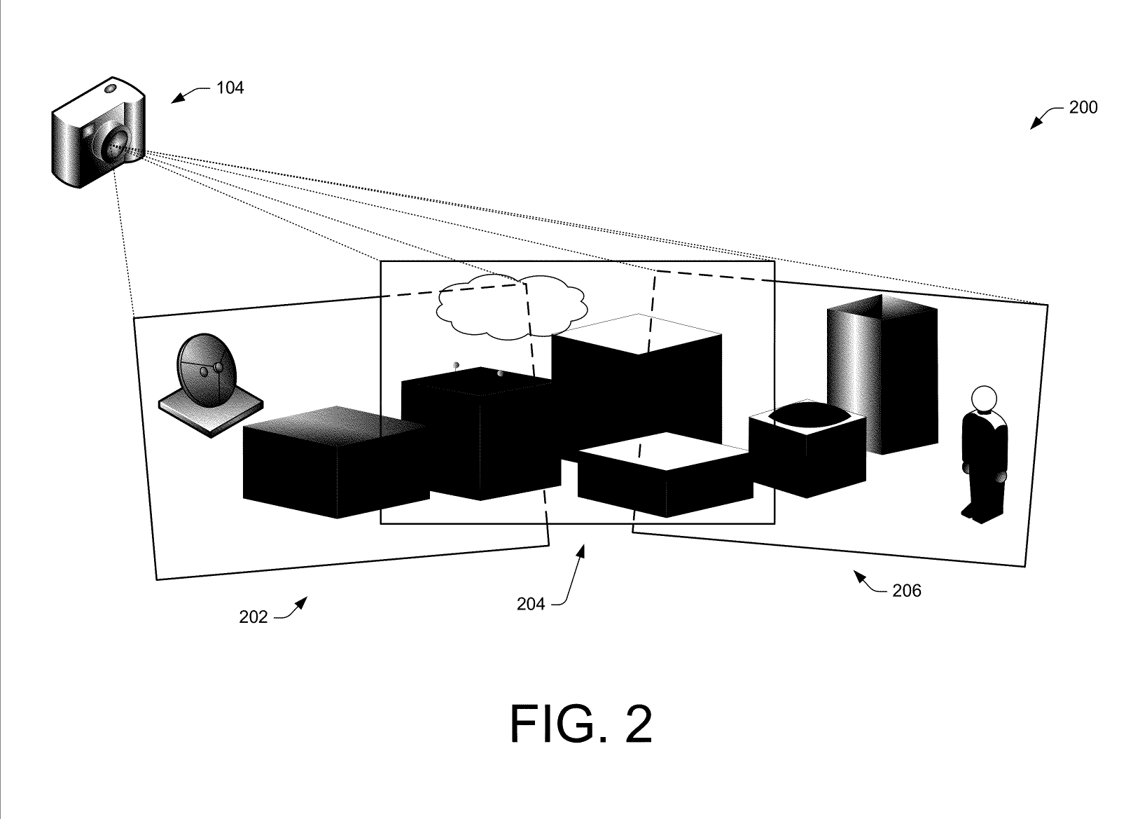

FIG. 2 shows illustrative grouping 200 of images 202, 204, and 206 generated by the camera 104 in the scenario 100 shown FIG. 1. In this example, the scene 106 is represented by three different images 202, 204, and 206. The number of separate images is merely illustrative and a smaller number or greater number of images may also be modified by the techniques disclosed herein.

The separate images 202, 204, and 206 may be aligned and stitched together to create a single image. Techniques for aligning images that contain overlapping content and techniques for stitching together images following alignment are known. For example, image features in the separate images 202, 204, and 206 may be registered using any known techniques for image stitching. In one implementation, the images 202, 204, and 206 may be projected onto a common coordinate system. Then any conventional graph-cut technique may be applied to stitch the images together. After stitching the images together, visual discrepancies at the location of the stitching may be reduced by Poisson blending, efficient blending, flexible screen manipulation, or similar techniques. Such techniques will be well known persons having ordinary still in this field.

No matter how the images 202, 204, and 206 are aligned and stitched together, projecting a three-dimensional scene 106 onto a two-dimensional image will create distortion. This distortion is unavoidable in projections. Different projections are used to warp the three-dimensional scene 106 into a two-dimensional image. Example projections include perspective, cylindrical, and spherical projections. The perspective projection preserves straight lines but may severely stretch shapes. The cylindrical and spherical projections maintain local shapes but bend straight lines. The use of a projection to display three-dimensional information in a two-dimensional format may contribute to the irregular boundaries of the stitched image.

Thus, the starting point for further manipulation is a stitched image with an irregular border. The image representing a combination of images 202, 204, and 206 is one example. However, an irregular shaped-image generated by a technique other than image stitching is equally amenable to the rectangling techniques discussed below.

### Mesh-Free Local Warping

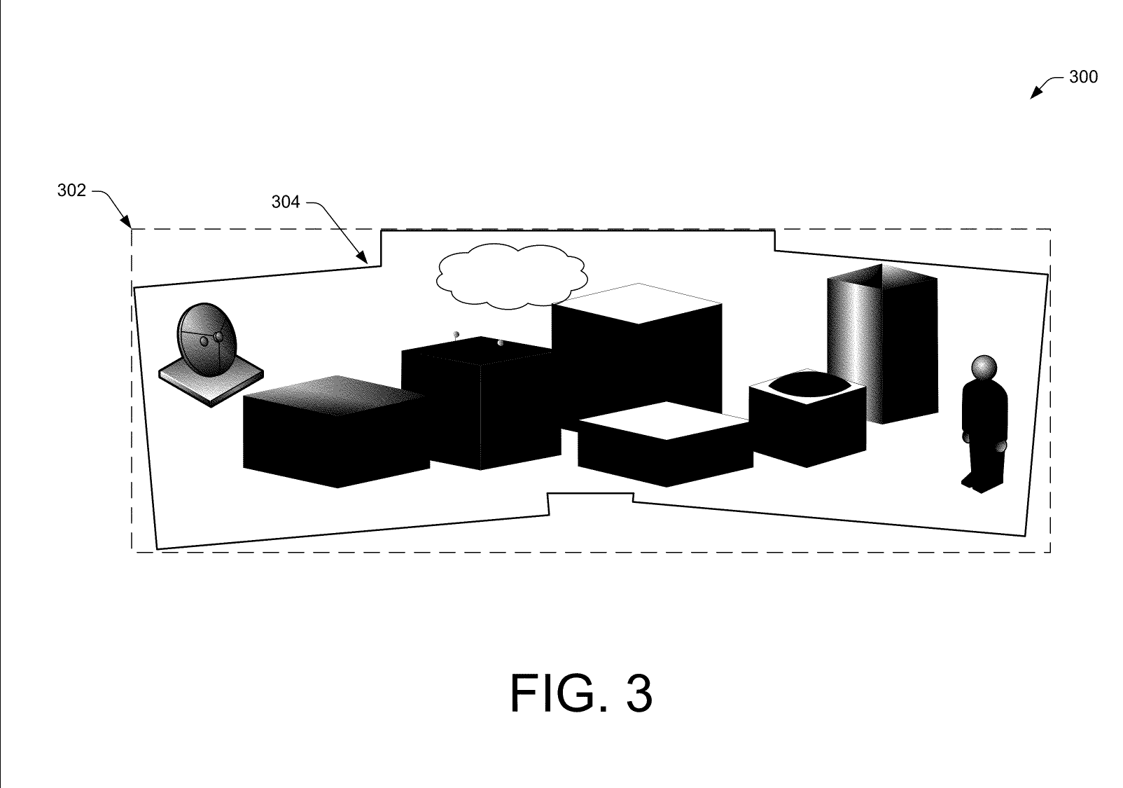

FIG. 3 shows a target rectangle 302 surrounding the stitched image 304. The target rectangle 302 is a rectangle with square corners within which the irregular-shaped image 304 fits completely. The irregular-shaped image 304 has a shape represented here by the solid line which will be warped to fill the target rectangle 302 represented here by the dotted line. The warping or stretching of the irregular-shaped image 304 is done by mathematical manipulation of data representing the image, but for ease of visualization the technique may be analogized to stretching an image printed on a flexible rubber sheet. The rubber sheet begins with a shape and location as shown by the solid line 304 and is stretched into a rectangle shown by the dotted line 302. However, in order to create a visually attractive rectangular-shaped image, the stretching is not uniform or equally distributed. Thus, the techniques described herein may be analogized to making different portions of the rubber sheet more or less flexible.

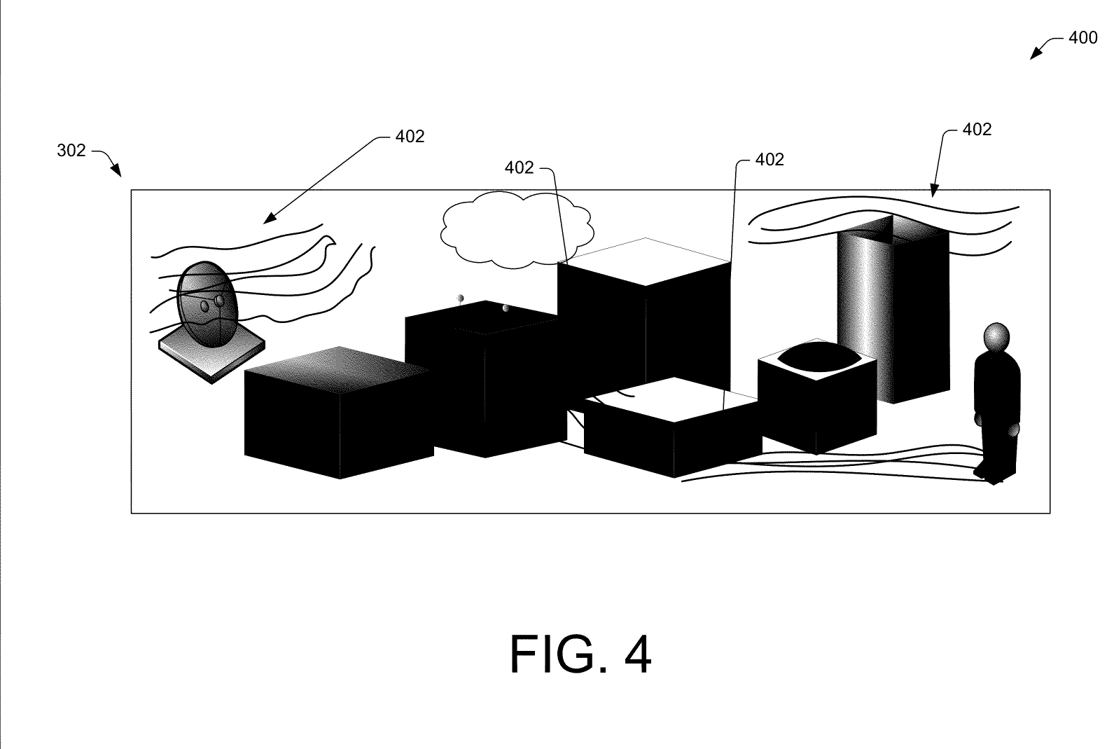

FIG. 4 shows an illustrative stretched image 400 that fills the target rectangle 302. One technique for this initial stretching is a modified application of the Seam Carving algorithm by Avidan and Shamir 2007 (Seam carving for content-aware image resizing. In SIGGRAPH 2007). The Seam Carving algorithm inserts horizontal and/or vertical seams 402 through the image, expanding the image horizontally and/or vertically. Addition of seams 402 in appropriate number and locations warps the stitched image into a rectangular image that fills the target rectangle 302. This warping creates a displacement field that represents the difference in position of pixels in the stitched image prior to and after the seams 402 are added. The distortion is locally distributed near the seams so this type of image warping may be referred to as “local warping.” Some techniques for local warping may reshape images only by expanding the image without shrinking or compressing any portions of the image. Although the stretched image 400 is now rectangular, local warping can introduce undesirable distortions.

### Mesh-Based Global Warping

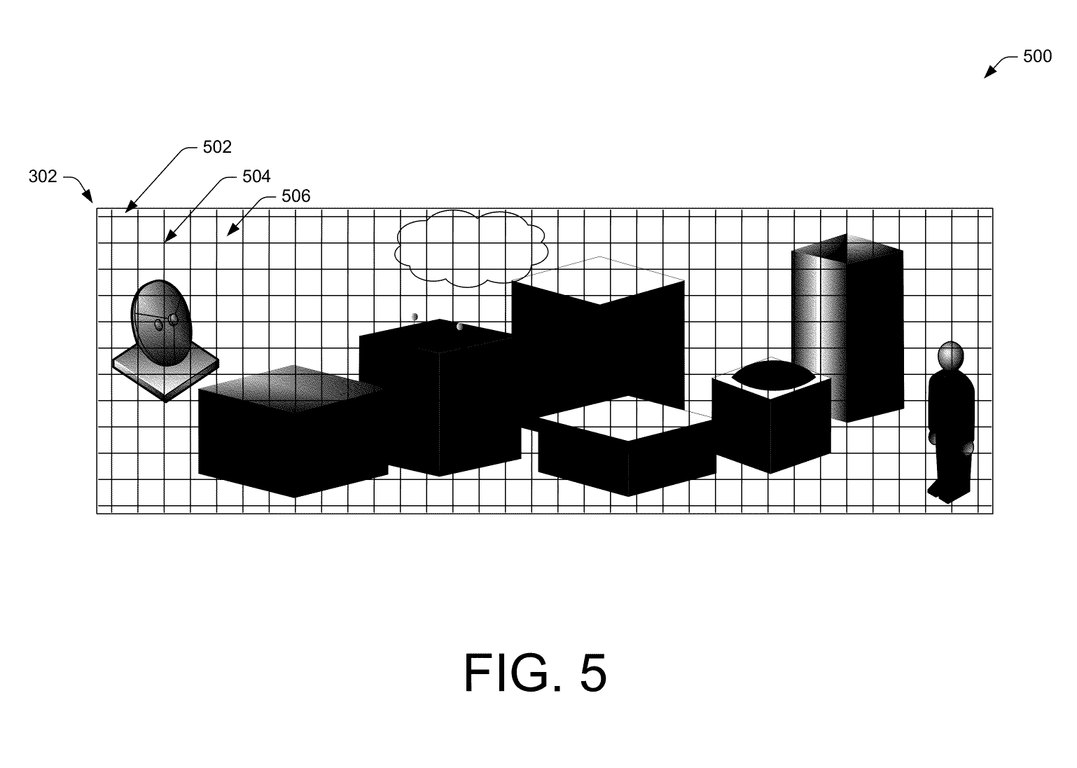

FIG. 5 shows a representation 500 of a mesh 502 placed over the stretched image 400 created by the local warping shown in FIG. 4. In the implementation shown in representation 500, the mesh 502 is a grid mesh but the mesh may be of other shapes such as triangles etc. The mesh 502 may be a relatively fine mesh or a relatively coarse mesh. In some implementations, the mesh 502 may have between about 100 and 1000 vertices 504, between about 200 and 600 vertices 504, or about 400 vertices 504. Four vertices 504 define a cell 506 of the mesh 502. In some implementations, the image content within a given cell 506 of the mesh 502 may be manipulated in the same way. In representation 500, the mesh 502 is a regular mesh that is not warped and the mesh 502 is overlaid on a rectangular shape 302. It is simpler to overlay a regular mesh 502 on the rectangle 302 than on the irregular-shaped image 304.

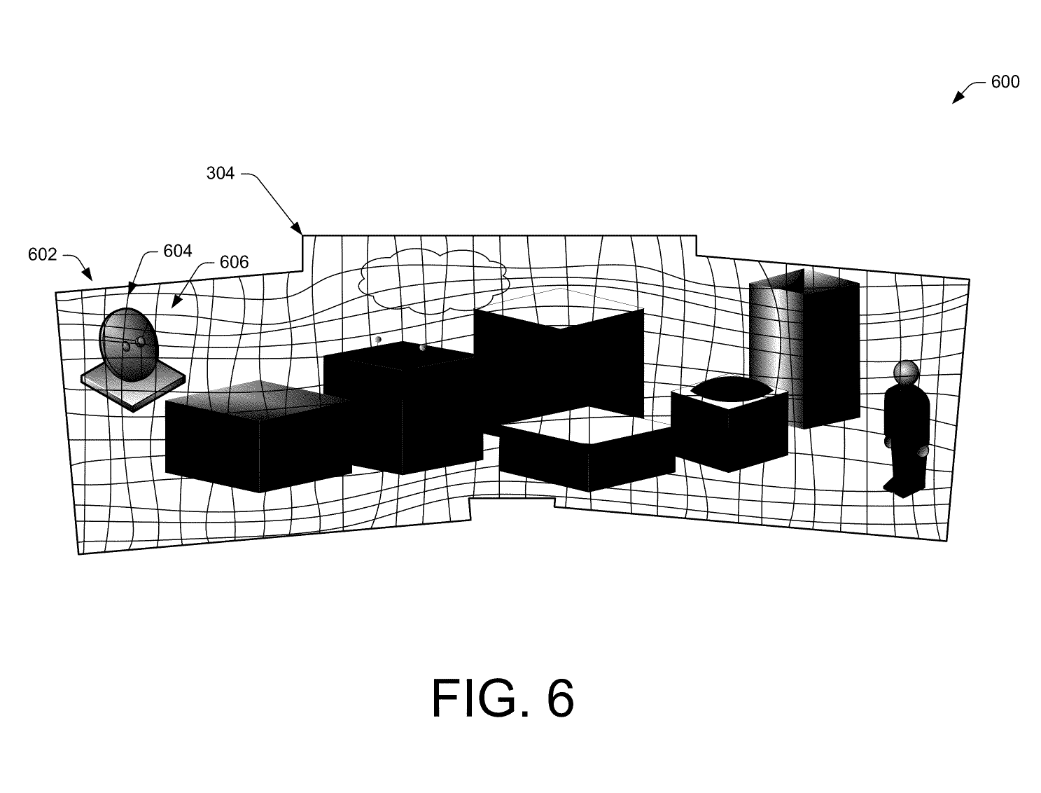

FIG. 6 shows a representation 600 of the regular mesh 502 from FIG. 5 warped into a warped mesh 602 by moving all the mesh vertexes 504 from the regular mesh 502 into an input domain defined by the shape of the irregular-shaped image 304. This creates the warped mesh 602 with mesh vertexes 604 and mesh cells 606 that correspond to the mesh vertexes 504 and mesh cells 506 of FIG. 5. The movement of the mesh vertexes 604 is based on the displacement field created by the local warping in FIG. 4. Thus, we obtain a warped mesh 602 placed on the input image with irregular boundaries as shown by the border of the irregular-shaped image 304. Subsequent warping of the image, discussed below, is based on this mesh 602. The stretched image 400 generated by local warping and shown in FIG. 5 may be discarded once the warped mesh 602 is generated.

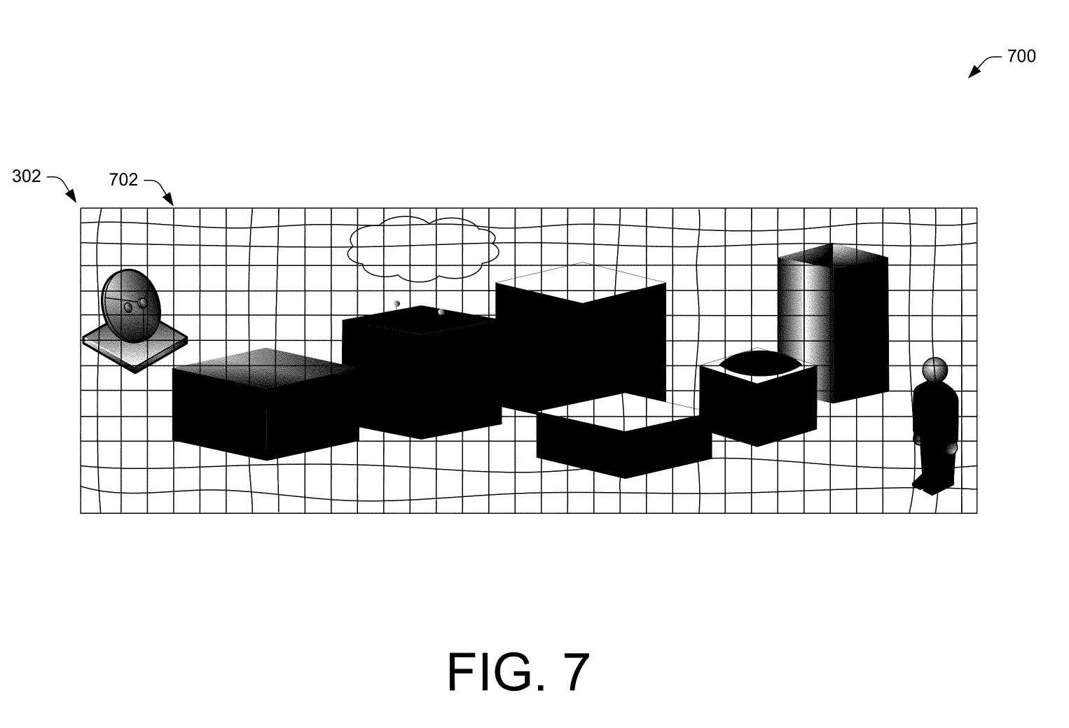

FIG. 7 shows an illustrative warped image 700 shaped to fill the target rectangle 302 from FIG. 3. The warping of the image 700 is based on the warping of the mesh 602 from FIG. 6 into the mesh 702 shown here in FIG. 7. Warping of the mesh 602 of FIG. 6 into the mesh 702 of FIG. 7 may be performed by optimizing one or more global energy functions that describe the positioning of the mesh 702. This is referred to as “mesh-based global warping.” In one implementation, the global energy functions may include a function causes the mesh 702 to fill the target rectangle 302, a function that preserves straight lines, and a function that preserves high-level properties such as shapes. Optimization of the mesh 702 may be based on a solution that finds a lowest global energy for the combination of the one or more global energy functions. Illustrative global energy functions are discussed in greater detail below.

### Illustrative Processes

For ease of understanding, the processes discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process, or an alternate process. Moreover, it is also possible that one or more of the provided operations may be modified or omitted.

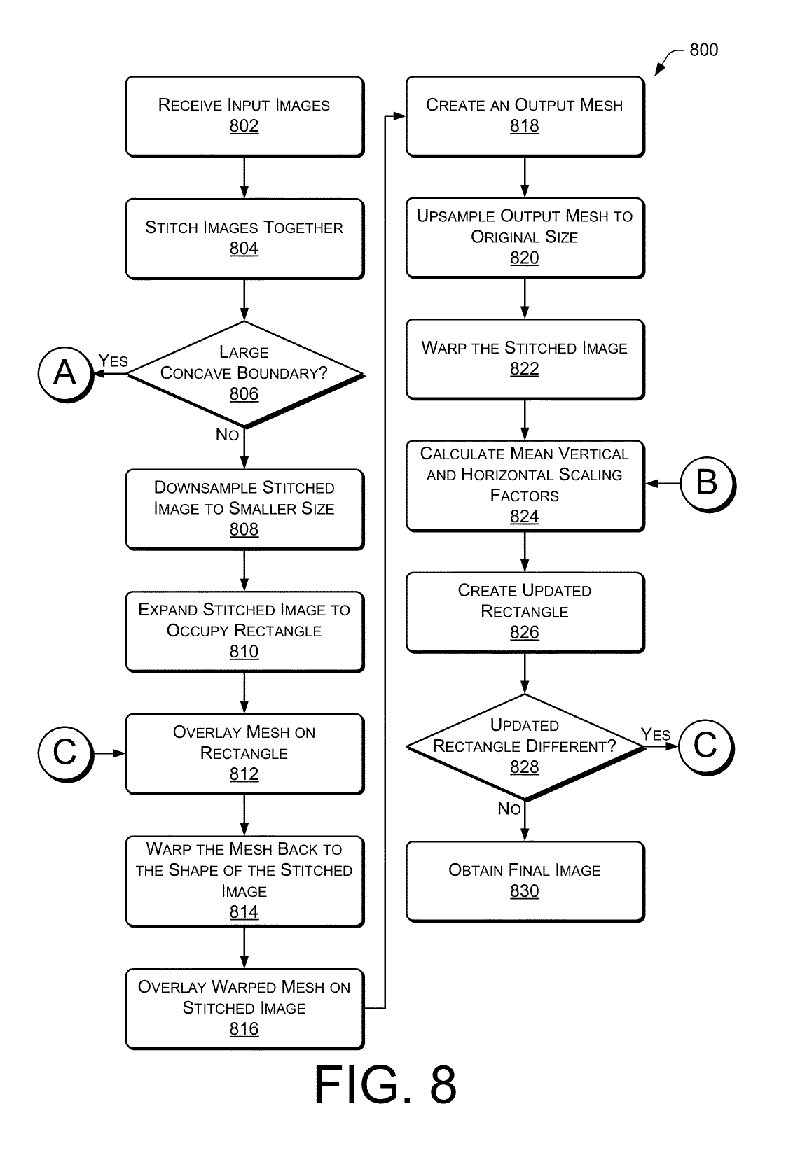

FIG. 8 shows an illustrative process 800 for creating a single rectangular output image from a plurality of overlapping input images. At 802 one or more input images are received. Any number of input images may be received. The input images may be received by a file transfer via a network, read from a memory associated with an image capture device, or from any other source. As a non-limiting example, the input images may be a plurality of images (e.g., three images) of a panoramic scene as shown in FIG. 2.

At 804, the images received at 802, if more than one image is received, are stitched together to create a single image. The single image may be a stitched image that has irregular boundaries. The images may be stitched together by a technique that uses the graph cut algorithm, the gradient-domain composting algorithm, and/or additional image stitching techniques.

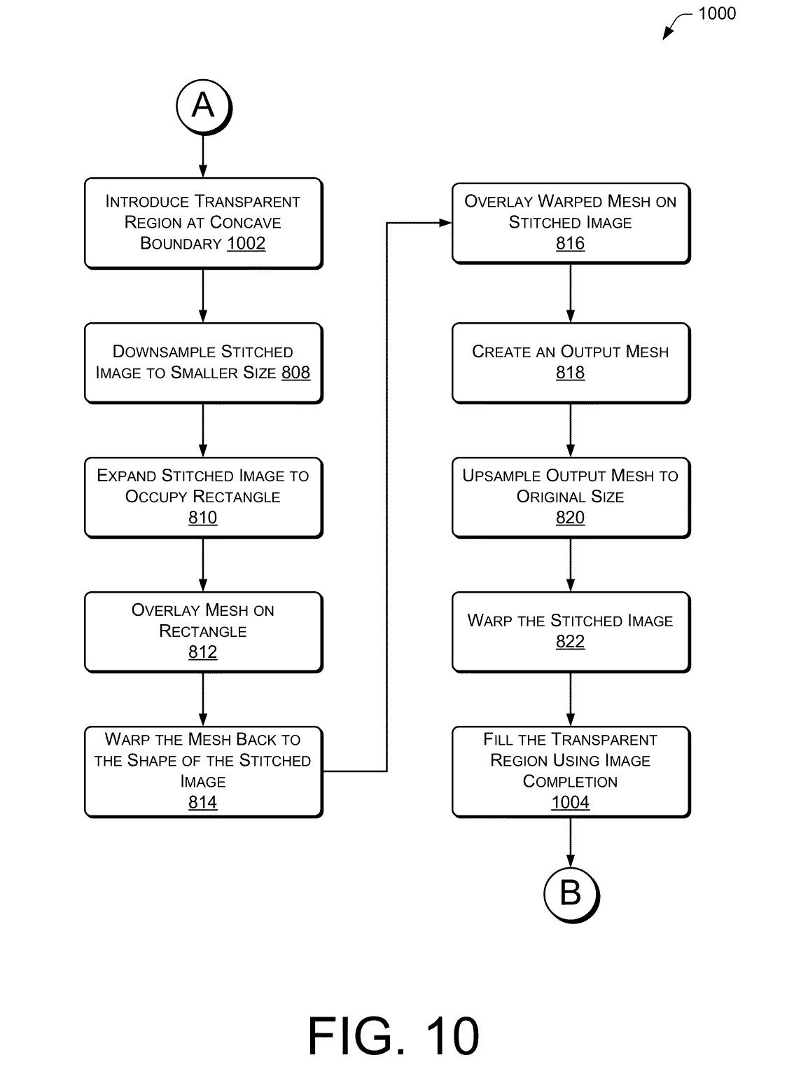

At 806, it is determined if the stitched image generated at 804 has a large concave boundary. The rectangling technique describe here may distort content near very concave boundaries. Accordingly, if a large concave boundary is identified, process 800 proceeds along the “yes” path to “A” which is shown on FIG. 10. If there are no large concave boundaries on the stitched image, then process 800 proceeds along the “no” path to 808.

At 808, the stitched image from 804 is downsampled from an original image size to a smaller image size. Because the warping is mostly smooth, manipulations calculated for a smaller image scale can be used on a larger image size. The stitched image may be downsampled to a fixed size such as, for example, 1 mega-pixel. Both local warping and global warping may be performed on the downsampled image. The downsampling may increase processing speed as compared to performing the same warping on a larger, original sized image.

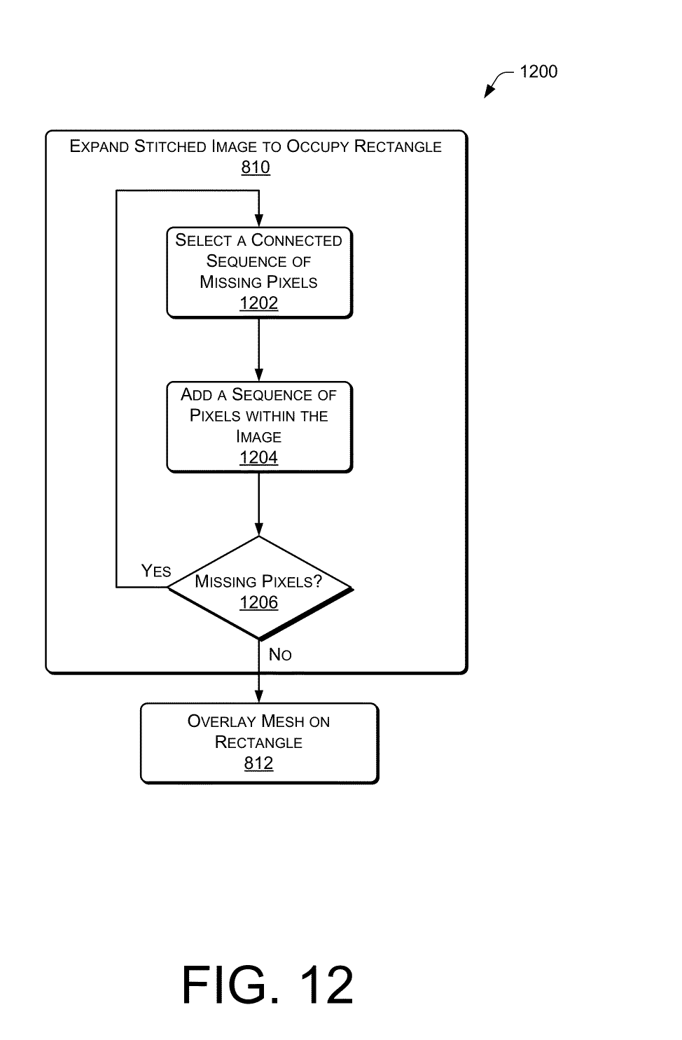

At 810, the stitched image is expanded to occupy a target rectangle. The target rectangle may be a bounding box that frames the stitched image. One example of a target rectangle that is a bounding box is the rectangle 302 shown in FIG. 3. The target rectangle may also be any other shape of rectangle. For example the target rectangle may be a rectangle having a pre-defined aspect ratio such as 4:3 or 16:9. This expansion creates a stretched, rectangular image (e.g., image 400 of FIG. 4). One illustrative technique for expanding the stitched image is shown in FIG. 12 and discussed below.

At 812, a mesh is overlaid on the stretched, rectangular image from 810. The mesh may have any configuration such as, for example, a grid mesh of squares or a mesh of triangles. The mesh may completely cover the image so that every pixel in the image has a location within a cell of the mesh. FIG. 5 shows the application of a square, grid mesh to a stretched image.

At 814, the mesh is warped back to the shape of the stitched image of 804. One example of this type of warping is shown in FIG. 6. The warping may be performed by repositioning grid vertexes of the mesh using a displacement field that represents the displacement that is created in the stitched image of 804 by expansion of the stitched image to occupy the target rectangle at 810. Thus, the displacement which was applied to expand the input image is used in reverse to shrink the mesh.

At 816, the warped mesh created at 814 is overlaid on the stitched image from 804. This creates a warped mesh that started as having the dimensions of the target rectangle, but now covers the input image from 804.

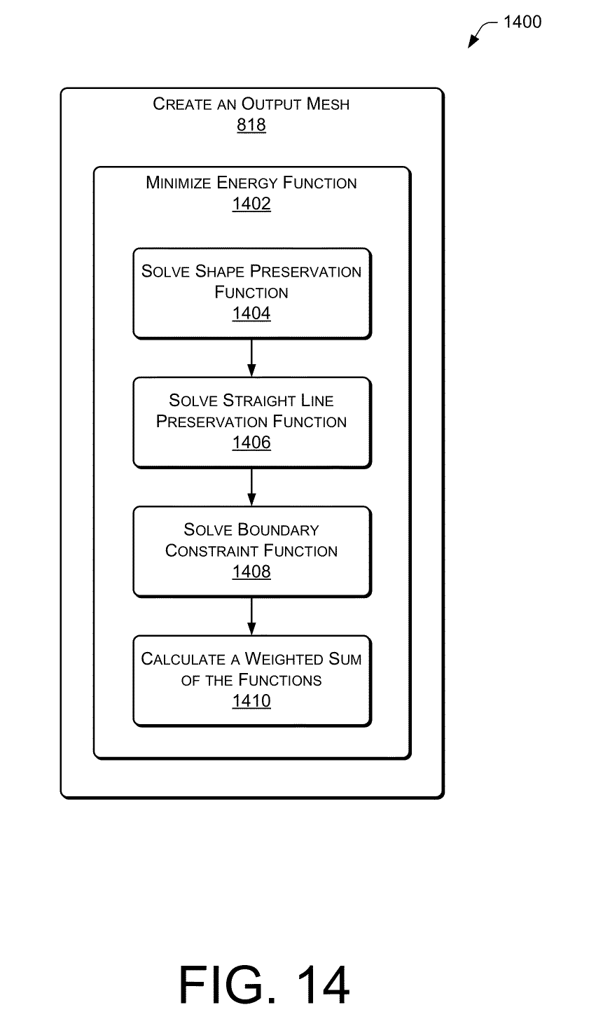

At 818, and output mesh is created from the mesh overlaid at 816. The output mesh may be created by changing positions of vertices of the warped mesh. Thus, all the different configurations of the meshes from 812-818 may have the same number of vertices: it is the relative position of the vertices that changes as the meshes are warped and reshaped. In some implementations, the output mesh may be created by changing positions of the vertices in a way that minimizes or reduces an energy function. Energy function may include a shape preservation function, a straight-line preservation function, and a boundary constraint function. Details of the one illustrative energy function are shown in FIG. 14 and described in greater detail below.

At 820, the output mesh maybe upsampled to the original size in order to create an original size output mesh and reverse the downsampling to smaller size performed at 808. The upsampling may be performed by using a displacement map and bilinear interpolation to warp the full resolution input image.

At 822, the stitched image generated at 804 is warped according to the output mesh generated at 818. If downsampling and upsampling are performed, the warping performed is according to the upsampled output mesh from 820. This creates a rectangular image that contains the content from the stitched image at 804. This rectangular image may be created without cropping so that all the content from the input image or images is present. This rectangular image may also be created without using any additional synthesized content such as the type of content generated by image completion techniques. However, there may be undesirable stretching for some images following the warping at 822.

A post-processing technique for stretching reduction may be performed at 824. At 824, the target rectangle may be updated by calculating mean vertical and horizontal scaling factors representing changes in the shape of the image from the irregular-shaped input image to the rectangular output image. The mean vertical and horizontal scaling factors may be calculated from changes in vertical and horizontal dimensions of cells of the output mesh at 820 compared to cells in the input mesh at 812.

Each vertex in the input mesh may be denoted as having a position on an x, y, coordinate system as (\hat{X},ŷ) and each vertex in the output mesh may be denoted as having a position (x,y). An x-scaling factor sₓ may be calculated as sₓ=(xₘₐₓ−xₘᵢₙ)/(\hat{x}ₘₐₓ−\hat{x}ₘᵢₙ) for cells of the mesh. The mean x-scaling factor s̅ₓ is the average of sₓ for the cells of the mesh. The target rectangle width is then scaled by 1/ s̅ₓ. Accordingly, if the mean y-scaling factor is 1, then the within the target rectangle will not change. A y-scaling factor s_{y} may be calculated as s_{y}=(yₘₐₓ−yₘᵢₙ)/(ŷₘₐₓ−ŷₘᵢₙ) for cells of the mesh. The mean y-scaling factor §_{y} is the average of s_{y} for the cells of the mesh. The target rectangle width is then scaled by 1/ s̅_{y}.

At 826, and updated target rectangle is created by scaling of the vertical dimension of the target rectangle by the reciprocal of the mean vertical scaling factor and the scaling of the horizontal dimension of the target rectangle by the reciprocal of the mean horizontal scaling factor to create an updated target rectangle.

At 828, it is determined if the updated target rectangle is different from the original target rectangle. As indicated above, if both the x-scaling factor and the mean y-scaling factor are 1 then the updated target rectangle would be the same as the original target rectangle and process 800 would follow the “no” path to 830. If, however, one or both of the horizontal or vertical dimensions of the updated target rectangle are different from the dimensions of the original target rectangle, then process 800 would follow the “yes” path and return to 812 for continued processing using the updated target rectangle.

At 830, a final image is obtained. The final image is rectangular in shape and preserves the shapes and straight lines within the input images. The final image is created using the final mesh by bilinearly interpolating the displacement of pixels from the displacement of the mesh vertexes. If there are missing pixels on a boundary because a grid line does not fit the irregular boundary of the stitched image, the missing pixels may be filled in using the color of the nearest known pixels.

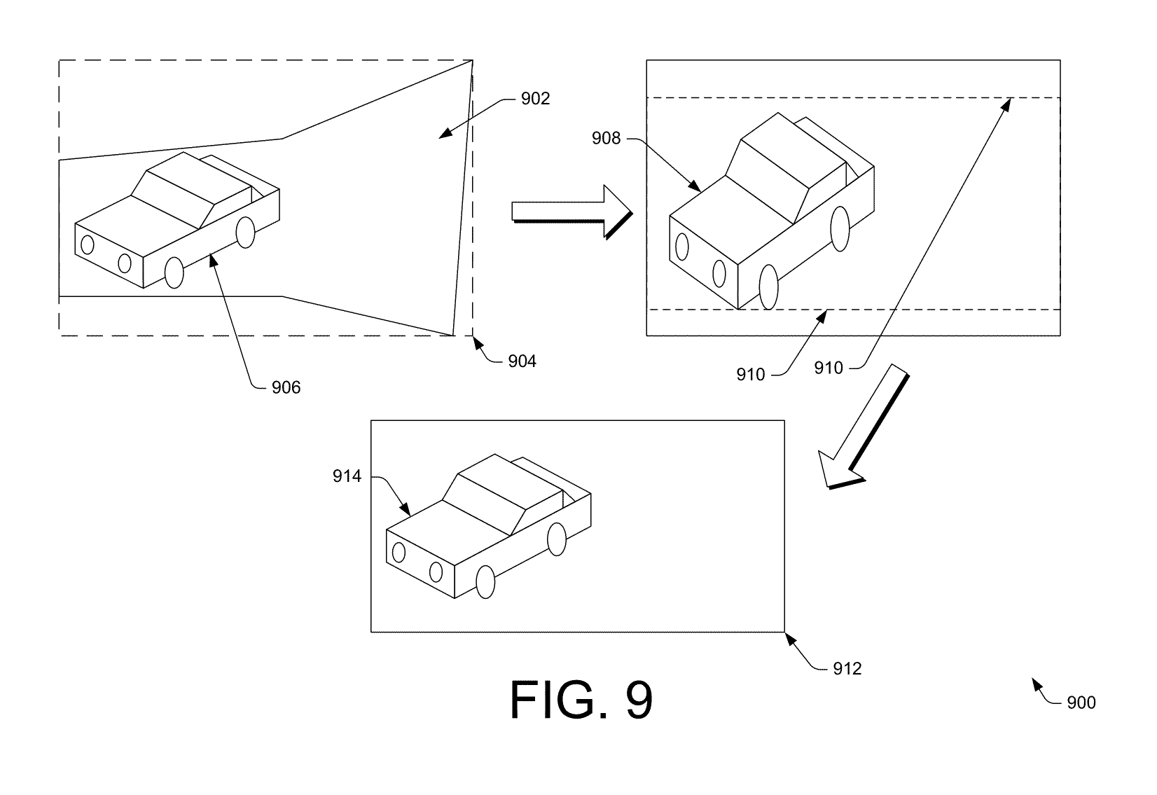

FIG. 9 shows an illustrative view 900 of how stretching of an image 902 may be reduced by changing the size of a target rectangle 904. The changes to image 902 shown in FIG. 9 may correspond to blocks 824-830 of FIG. 8. The image 902 includes an object 906 (i.e., a car) that is vertically stretched as shown by object 908 when local and global warping are performed absent post-processing stretching reduction. In this example, the target rectangle 904 (which is the bounding box of image 902) has an unwanted aspect ratio. This problem of visible stretching may be more obvious in perspective projections. Identifying an updated target rectangle using the techniques of block 824 may result in a reduction in the vertical dimension of the target rectangle as show by dotted lines 910. Although not shown in this example, the horizontal dimension of the target rectangle may be changed as well. The updated target rectangle 912 reduces the stretching of the object 914.

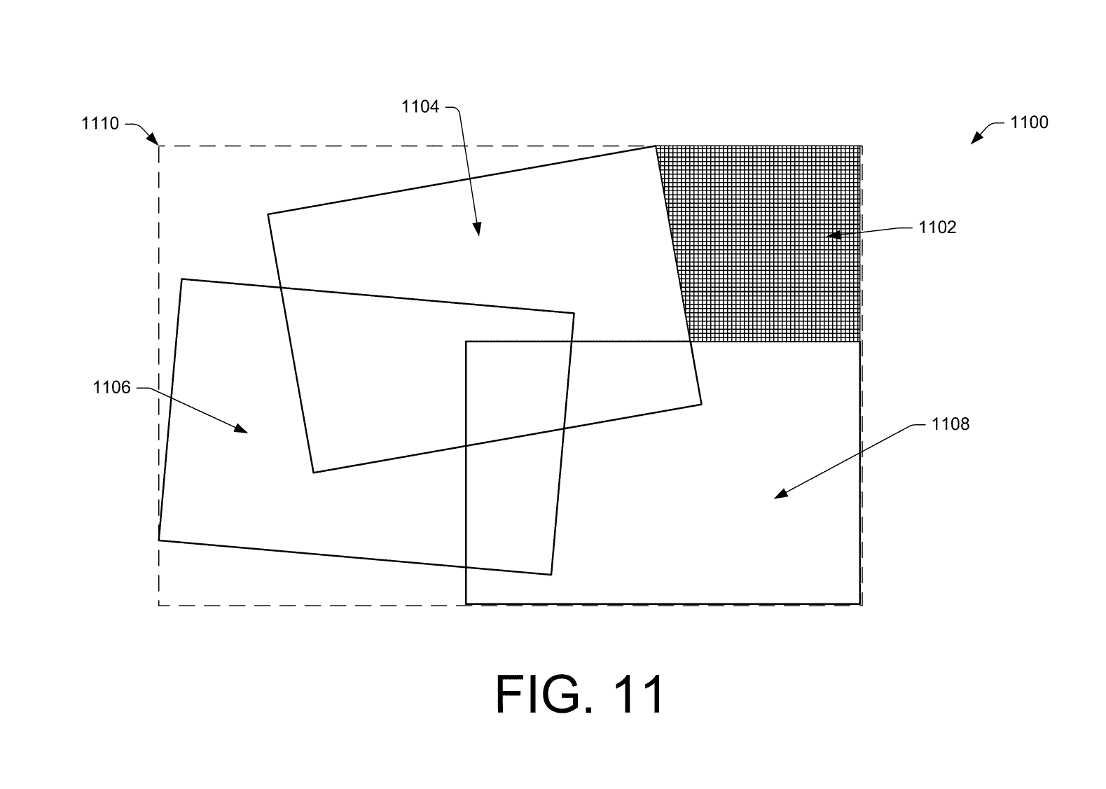

FIG. 10 shows an illustrative process 1000 that is a modification of process 800 from FIG. 8. In process 800 at 806, it is determined if the stitched image has a large concave boundary. When the irregular boundary of an image is very concave, reshaping that image into a rectangle may cause severe local distortion. One technique to reduce the local distortion is, at 1002, to introduce a transparent region in the image at the concave boundary. The transparent region may be introduced manually by a user. A visual representation of this is shown in FIG. 11.

Following addition of the transparent region at 1002, blocks 808-822 of process 800 are performed with the transparent region treated the same as other portions of the stitched image. The transparent region is essentially treated as if it were made up of known pixels so this changes the original shape of the stitched image.

At 1004, once the image has been warped into the shape of the target rectangle, the transparent region is filled using image completion. Any known image completion technique may be used. Although other implementations of the rectangling techniques described herein can reshape an image without use of image completion, in some instances adding synthetic content can create a more visually attractive final result than the location distortion that may be caused by warping to fill a highly concave boundary.

FIG. 11 shows a view 1100 of the introduction of a transparent region 1102 between a stitched image made up of input images 1104, 1106, and 1108 and a target rectangle 1110. The transparent region 1102 is introduce at a very concave boundary and fills the space between the input images 1104 and 1108 and the target rectangle 1110 thereby removing the concave boundary.

FIG. 12 shows a process 1200 providing greater detail about block 810 from process 800. In this process 1200, block 810 includes blocks 1202-1204 that show one illustrative technique for expanding a stitched image to occupy a target rectangle.

At 1202, a connected sequence of missing pixels between an edge of the stitched image and a target rectangle is selected. In some implementations, the selected sequence of missing pixels may be the longest sequence of missing pixels out of all the sequences of missing pixels between the borders of the stitched image and the target rectangle.

At 1204, a sequence of pixels is added within the stitched image such that the added pixels shifts a portion of the stitched image toward the inside edge of the target rectangle. This shift fills all or some of the sequence of missing pixels. Thus, by adding pixels towards the middle of the image that edge of the image is moved closer to target rectangle. One example of this is shown in FIG. 4 where the added sequences of pixels 402 are placed within the image 400.

At 1206, it is determined if there are other missing pixels. If there are missing pixels then process 1200 proceeds along the “yes” path and returns to 1202. This process 1200 may be repeated until there are no longer any missing pixels within the target rectangle. At that point, the stitched image will have been expanded to fill the target rectangle. Thus, the stitched image will be warped into a rectangle by addition of seams throughout the stitched image. If it is determined at 1206 that there are no missing pixels, process 1200 proceeds along the “no” path to 812 and proceeds as process 800 shown in FIG. 8.

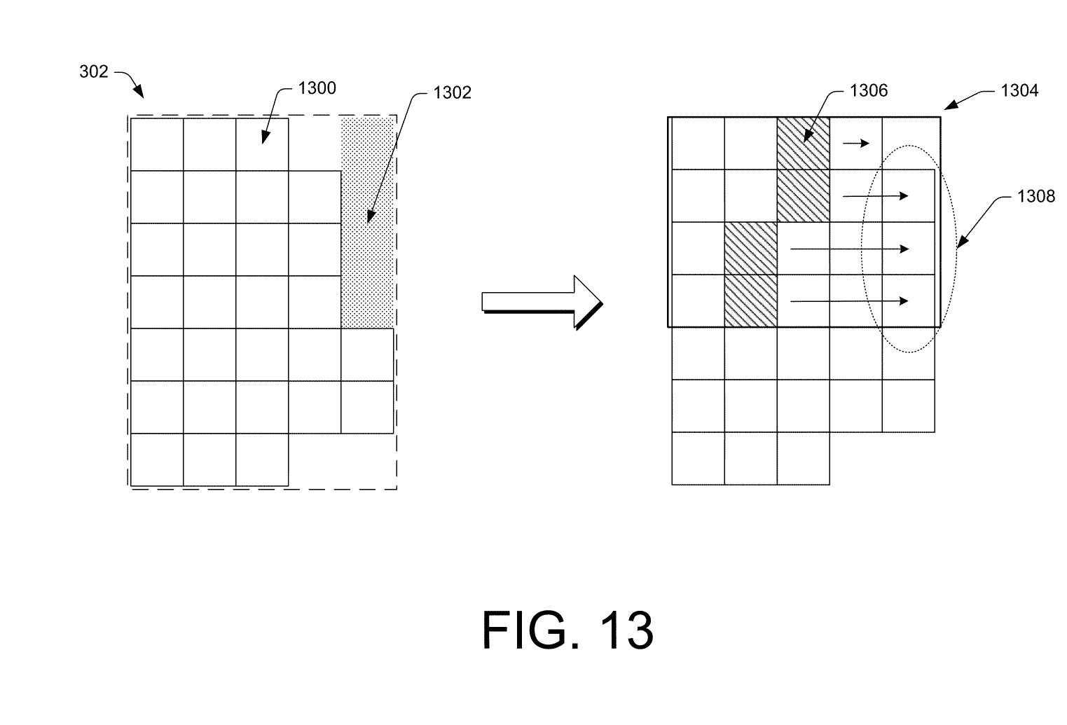

FIG. 13 shows an illustrative view of the techniques described above in FIG. 12. The dotted line 302 represents a portion of the target rectangle shown in FIG. 3. Each of the squares 1300 represents pixels of the stitched image. A “boundary segment” is a connected sequence of missing pixels 1302 on one of the four sides (i.e., top/bottom/left/right) of the target rectangular 302. Iterations of this process may select the longest boundary segment and insert one seam. In this example, the boundary segment 1302 is on the right side of the image. The next longest boundary segment may be on the bottom or any other edge of the image.

The Seam Carving algorithm adds seam of pixels through the entire width and height of the image shifting the one pixel vertically/horizontally. This technique modifies the Seam Carving algorithm by adding a seam not through the entire image but only through a sub-image 1304 that is part of the larger image. This technique can be used to change the boundary shape of the image by adding pixels at a seam 1306 through the sub-image 1304 which shifts other pixels 1308 to fill some or all of the missing pixels 1302. Here, the added pixels form a vertical seam 1306 through the sub-image. This seam 1306 shares the same starting and ending y-coordinates as the selected boundary segment 1302. The pixels on the right of this seam 1306 are shifted by one pixel to the right. Insertion of the seam 1306 reduces the number of missing pixels in the image by the number of pixels added in the seam 1306. Additions of a seam on the top/bottom/left side can be treated similarly. Seams may be repeatedly inserted to shift pixels until the target rectangle 302 has no missing pixel. For example, the Improved Seam Carving of Rubinstein et al. 2008 may be used to add the seam 1306.

If the sub-image 1304 contains missing pixels, a high or infinite cost may be assigned to the missing pixels to prevent the seam from passing the missing pixels. Inserting a seam is equivalent to computing a displacement field u(x). Let x=(x,y) denote the coordinates of an output pixel and u=(uₓ,u_{y}) denote displacement. The output pixel value can be obtained by warping the input image:

Iₒᵤₜ(x)=Iᵢₙ(x+u(x)) (1)

where Iᵢₙ and Iₒᵤₜ represent the input and the current output images. For the example in FIG. 13, the displacement u is (−1, 0) for all pixels on the right of this seam, and zero for all other pixels. The displacement field u is obtained when all of the seams are added.

FIG. 14 shows a process 1400 providing greater detail about block 818 from process 800. In one implementation, the output mesh may be created through a global warping process that optimizes an energy function. Let the input mesh be \hat{V} and let the output mesh be V. The mesh V may be parameterized as {vᵢ}, where vᵢ=(xᵢ,yᵢ) is the position of a grid vertex. At 1402, the energy function for the output mesh V is minimized. Minimization or reduction of the energy function may include solving a shape preservation function, solving a straight-line preservation function, solving a boundary constraint function, and calculating a weighted sum of those functions.

At 1404, the shape preservation function is solved. The shape preservation function is a similarity transformation that minimizes or reduces distortion in relatively more important regions of the stitched image while increasing distortion in relatively less important regions of the stitched image. Importance of regions of the stitched image may be based at least in part on an importance map. Shape-preserving energy E_{S} encourages each cell of the mesh to undergo a similarity transformation. Similarity transformations include translation, rotation, and scaling. Any known similarity transformation technique may be used.

The shape preservation function may be:

$${E}_{S} ( V ) = \frac{1}{N} {\sum }_{q} {‖ ( {{A}_{q} ( {A}_{q}^{T} {A}_{q} )}^{- 1} {A}_{q}^{T} - I ) {V}_{q} ‖}^{2} . \qquad ( 2 )$$

Where N is a number of grids in the mesh, q is a grid index, I is a unit matrix, and A_{q} is an 8×4 matrix and V_{q} is an 8×1 vector on the grid:

$${A}_{q} = [ \begin{matrix}{\hat{x}}_{0} & - {\hat{y}}_{0} & 1 & 0 \\ {\hat{y}}_{0} & {\hat{x}}_{0} & 0 & 1 \\ ⋮ & ⋮ & ⋮ & ⋮ \\ {\hat{x}}_{3} & - {\hat{y}}_{3} & 1 & 0 \\ {\hat{y}}_{3} & {\hat{x}}_{3} & 0 & 1\end{matrix} ] , {V}_{q} [ \begin{matrix}{x}_{0} \\ {y}_{0} \\ ⋮ \\ {x}_{3} \\ {y}_{3}\end{matrix} ] . \qquad ( 3 )$$

Here (x₀, y₀), . . . , (x₃, y₃) is used to denote pairs of coordinates of the output cell (four pairs for a mesh with square cells), and (\hat{x}₀,ŷ₀), . . . , (\hat{x}₃,ŷ₃) denote the pairs of coordinates of the input cell. E_{S} is a quadratic function of V. The shape preserving function may omit saliency weights because panoramic images can cover a wide variety of content and contain no particularly salient object.

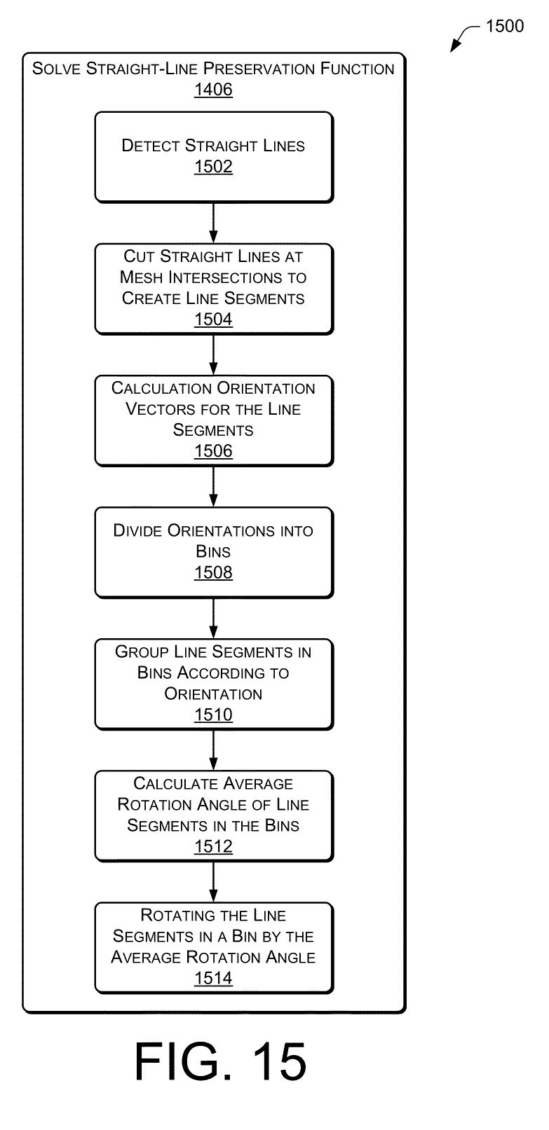

At 1406, a straight-line preservation function is solved. The straight-line preservation function solves for a line preserving energy E_{L} that encourages keeping straight lines straight and keeping parallel lines parallel. This straight-line preservation function is discussed in greater detail in FIG. 15.

At 1408, a boundary constraint function is solved. The boundary constraint function stretches vertexes on the outer boundary of the warped mesh to the target rectangle. Application of boundary constraints may be visualized as dragging the vertexes on the outside edges of the mesh to a defined boundary. The boundary may be a rectangle as discussed in the example above. However, the boundary constraint function may be used to create shapes other than rectangles.

The boundary constraint term E_{B} may be defined as:

E_{B}(V)=Σᵥ_{ᵢ}_{εL}xᵢ²+Σᵥ_{ᵢ}_{εR}(xᵢ−w)²+Σᵥ_{ᵢ}_{εT}yᵢ²+Σᵥ_{ᵢ}_{εB}(yᵢ−h)². (4)

Here L/R/T/B denote the left/right/top/bottom boundary vertexes, and w/h denotes the width/height of the target rectangle (e.g., the bounding box 302). Constraints may be limited to only one of the two coordinates of each boundary vertex, i.e., a vertex on the top boundary may be free to move horizontally and a vertex on a left boundary may be free to move vertically.

At 1410, a total sum of the shape preservation function, the straight line preservation function, and the boundary constraint function is calculated. The energy function may be minimized or reduced by minimizing or reducing this sum. The three functions may be separately weighted to create a weighted sum that reflects different levels of emphasis on different aspects of the warping. A total energy function E may be represented as:

E(V,{θₘ})=E_{S}(V)+λ_{L}E_{L}(V,{θₘ})+λ_{B}E_{B}(V), (5)

where λ_{L} and λ_{B} are two weights. The weight of the shape preservation function (E_{S}) may be set as 1. The numerical values of the weights are arbitrary; it is the relative value of the weights affects the final image. The weight for the boundary function (4) λ_{B} may be set as a large number approaching infinity (e.g., 10⁸) to impose a hard boundary constraint. The line preservation weight λ_{L} is the main influential parameter in this algorithm. Experimental results show that this algorithm works consistently well when λ_{L} is at least ten times larger than the (e.g., λ_{L}≧10). In some implementations, including the example below, λ_{L} may be set at 100. This means the importance of line preservation (E_{L}) is higher than shape preservation (E_{S}) to creating visually pleasing results. This is likely because human eyes are more sensitive to bend straight lines than to distorted shapes. Thus, the weight for the line preservation function may be about 10-100 times larger than the weight applied to the shape preservation function and the weight for the boundary function may be about 10⁶ times larger than the weight applied to the line preservation function. This relative weighting “forces” a rectangular shape with a strong preference to keep lines straight at the cost of distorting shapes.

FIG. 15 shows an illustrative process 1500 for solving the straight-line preservation function of block 1406. At 1502, straight lines are detected. Various techniques to detect line segments in an input image are commonly known.

At 1504, straight lines are cut where the straight lines cross a line of the mesh. Cutting the straight lines at the mesh intersections creates a plurality of line segments. With all the detected lines cut at the edges of the input mesh, each resulting line segment is then located inside one of the cells of the mesh.

At 1506, orientation vectors are calculated for the plurality of line segments. Given a line segment, the orientation vector e is calculated using the difference vector of the two end points of the line segment. Recall that this is the portion of a line located within a single cell of the mesh. The two end points of a line segment may be represented as a bilinear interpolation of the vertexes defining the cell of the mesh. Assuming, but not limited to, a square mesh there will be four vertexes creating quad vertexes V_{q}. Thus, e is a linear function of V_{q}. The input orientation vector of this line segment is ê.

At 1508, possible orientations of the line segments are divided into a number of bins. For example, the full 360° range of line orientations,

$$[ - \frac{π}{2} , \frac{π}{2} ] ,$$

may be divided into M number of bins. Any number of bins may be used. In some implementations, including the examples below, M=50 bins.

At 1510, the line segments are grouped into the bins according to the respective orientation vectors of the line segments. Given a target rotation angle θₘ, the goal is to minimize or reduce the following distortion of a line segment:

∥sRê−e∥², (6)

where

$$R = ( \begin{matrix}cos {θ}_{m} & - sin {θ}_{m} \\ sin {θ}_{m} & cos {θ}_{m}\end{matrix} )$$

is a rotation matrix, and s is a scaling factor of this line segment. Minimizing or reducing with respect to s gives: s=(ê^{T}ê)⁻¹ê^{T}R^{T}e. Substituting s into (4), shows that the distortion in (6) is a quadratic function of e:

∥Ce∥², (7)

where the matrix C is

C=Rê(ê^{T}ê)⁻¹ê^{T}R^{T}−I. (8)

Because e is a linear function of V_{q}, the distortion in (7) can be written as a quadratic function of V_{q}.

At 1512, an average rotation angle of the line segments in the respective bins is calculated. Thus, for a given bin an average rotation angle of the line segments group within that bin is calculated. Recall that all line segments in a bin are grouped together in that bin due to the similarity of the orientation vectors. Thus, the average rotation angle may be only slightly different from the respective individual rotation angles of the respective lines segments. To preserve straightness and parallelism, all the line segments in the same bin may share a common rotation angle θ. The line preserving energy E_{L} is defined as the average (i.e., mean) distortion for all line segments:

$${E}_{L} ( V , \{ {θ}_{m} \} ) = \frac{1}{{N}_{L}} {\sum }_{j} {‖ {C}_{j} ( {θ}_{m ( j )} ) {e}_{q ( j )} ‖}^{2} , \qquad ( 9 )$$

where N_{L} is the number of line segments. A line segment is indexed by j, and q(j) is the quad containing the line segment. The matrix Cⱼ(θₘ₍ⱼ₎), computed using (8), depends on the desired rotation angle θₘ₍ⱼ₎ of the bin that contains this line segment. E_{L} is a quadratic function of V. The energy for E_{L} is decoupled from the scaling factor(s) and the translation of each line segment. This decoupling results in E_{L} having fewer variables and parameters.

At 1514, the line segments which are in the same bin are rotated by the average rotation angle of that bin. The line preserving term E_{L} involves all these angles {θₘ}ₘ₌₁^{M}.

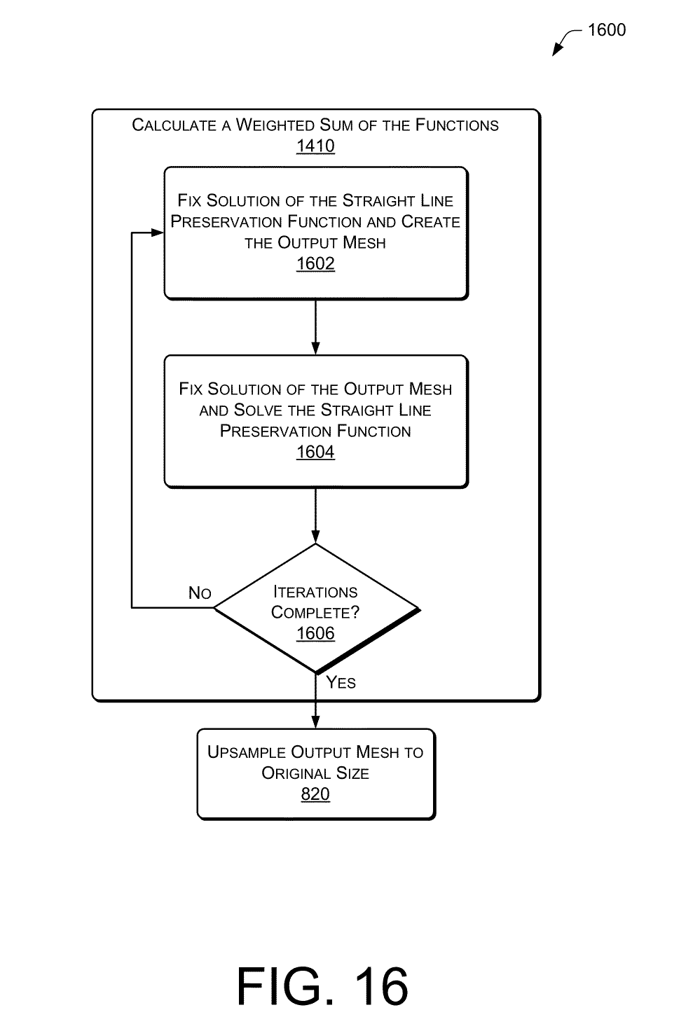

FIG. 16 shows an illustrative process 1600 for iteratively calculating the weighted sum of block 1410. In some implementations, the weighted sum of the shape preservation function, the straight-line preservation function, and the boundary constraint function may be calculated by using an alternating algorithm. Recall that both the shape preservation function and the boundary constraint function are functions of the grid V and that the straight-line preservation function is a function of the common rotation angle θ. Thus, solving for a minimum of the total energy may be represented as minimizing or reducing (V, {θₘ}) below a threshold level. Process 1600 may begin with the local warping result (i.e., simply a regular mesh as shown in FIG. 5).

At 1602, the target rotation angle θₘ of the straight-line preservation function is fixed and the total energy function is solved to create an output mesh V. When θₘ is fixed in equation (5), E becomes a quadratic function on V and can be optimized via solving a linear system. Since there may be only a few hundreds of vertexes in V, the running time of solving this linear system can be trivial in conventional computing implementations.

At 1604, the output mesh V is fixed and a solution is found for the target rotation angle θₘ of the straight-line preservation function. Because the θₘ for each of the bins is independent of the other bins, θₘ may be optimized separately for each of the bins. One illustrative solution is to minimize or reduce below a threshold:

$${min}_{{θ}_{m}} {\sum }_{j ∈ b in ( m )} {‖ {C}_{j} ( {θ}_{m} ) {e}_{q ( j )} ‖}^{2} . \qquad ( 10 )$$

At 1606, is determined if a sufficient number of iterations has been completed. This iterative process may be repeated for any number of iterations. For example, process 1600 may be repeated for 2-20 iterations, 5-15 iterations, or 10 iterations. The number of iterations may be predetermined or determined by a user based upon the user's subjective opinion of the resulting image. If the iterations are not yet complete, process 1600 proceeds along the “no” path and returns to 1602. If iterations are complete, process 1600 proceeds along the “yes” path to 820 of FIG. 8.

In some implementations, the minimum of θₘ in equation (10) may be found by using iterative solvers such as Newton's method. In other implementations, a non-iterative solution based on the intuitive meaning of (10) may be used to solve this energy function. The intuitive meaning of (10) is to find a common rotation angle θₘ for all the line segments in the m-th bin, such that θₘ approximates the relative angle between any line segment eⱼ and its counterpart êⱼ. This may be approximated by computing the relative angle between eⱼ and êⱼ for all line segments in the m-th bin, and taking the average of those angles as θₘ.

### Illustrative Computing Device

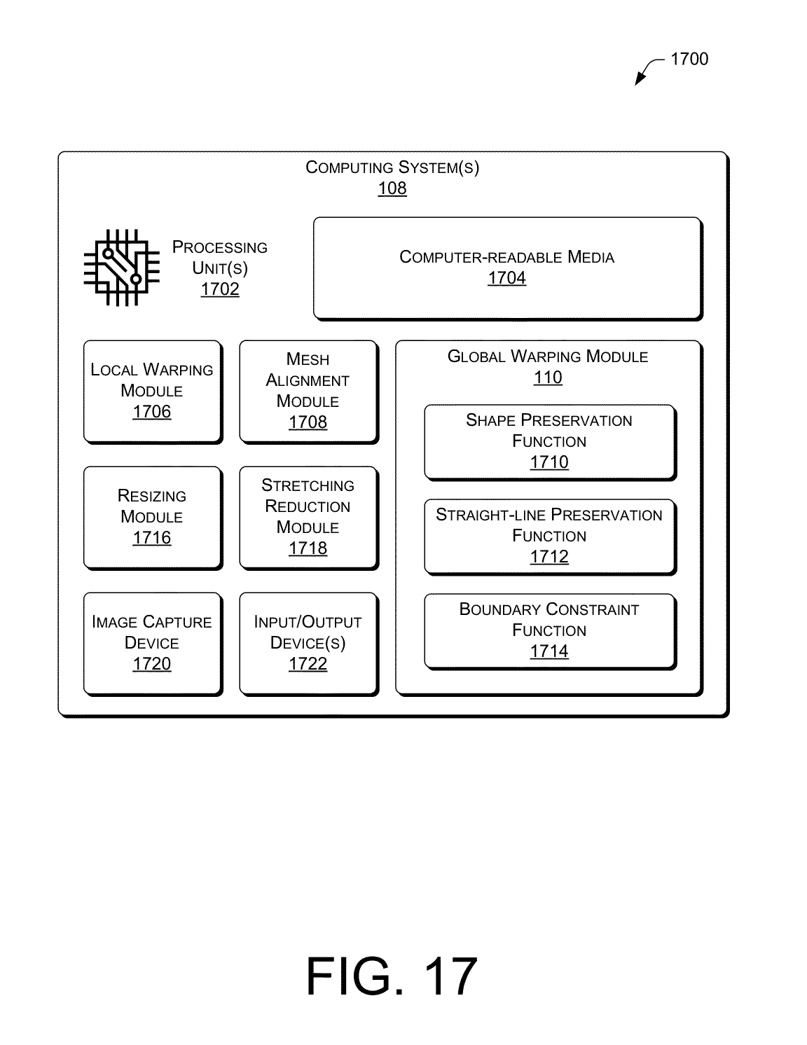

FIG. 17 shows an illustrative block diagram 1700 of components that may be included in the computing system(s) 108 of FIG. 1. The computing system(s) 108 contain one or more processing unit(s) 1702 and computer-readable media 1704 both of which may be distributed across one or more locations. The processing unit(s) 1702 may include any combination of central processing units (CPUs), graphical processing units (GPUs), single core processors, multi-core processors, application-specific integrated circuits (ASICs), and the like. One or more of the processing unit(s) 1702 may be implemented in software and/or firmware in addition to hardware implementations. Software or firmware implementations of the processing unit(s) 1702 may include computer- or machine-executable instructions written in any suitable programming language to perform the various functions described. Software implementations of the processing unit(s) 1702 may be stored in whole or part in the computer-readable media 1704.

The computer-readable media 1704 may include removable storage, non-removable storage, local storage, and/or remote storage to provide storage of computer readable instructions, data structures, program modules, and other data. Computer-readable media includes, at least, two types of media, namely computer-readable storage media and communications media. Computer-readable storage media includes volatile and non-volatile, removable and non-removable media implemented in any method or technology for storage of information such as computer-readable instructions, data structures, program modules, or other data. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer-readable storage media and communication media are mutually exclusive.

The block diagram 1700 shows multiple modules included within the computing system(s) 108. These modules may be implemented in software and alternatively, or additionally, implemented, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

A local warping module 1706 may warp an irregular-shaped input image into a first rectangular image. In some implementations, the local warping module 1706 may warp and image in the manner shown in FIG. 4. For example, the local warping module 1706 may implement the Seam Carving algorithm or similar technique to add seams within the image and expand the boundary shape of the image for fit a rectangle.

A mesh alignment module 1708 may overlay a regular mesh on the rectangular image, warp the mesh to a shape of the irregular-shaped input image making a warped mesh, and overlay the warped mesh on the irregular-shaped input image. Techniques performed by the mesh alignment module 1708 may be similar to the techniques shown in and discussed with FIGS. 5 and 6.

The global warping module 110 may warp the irregular-shaped input image into a second rectangular image by transforming the warped mesh into an output mesh such that an energy function describing locations of vertexes in the output mesh is minimized or in some implementations the energy function is not brought to an absolute minimum but is reduced below a threshold level. The energy function may preserve the appearance of shapes and the appearance of straight lines in the irregular-shaped input image. One illustrative result of manipulation performed by the global warping module 110 is shown in FIG. 7. One example of an energy function is equation (5).

In some implementations, global warping module 110 may include one or more of a shape preservation function 1710, a straight-line preservation function 1712, and a boundary constraint function 1714. Illustrative examples of these functions are equations (2), (9), and (4) respectively.

A resizing module 1716 may downsample the input image and then upsample the displacement map in order to allow the global warping module 110 to operate on a smaller image. Reducing the image size can increase the implementation speed of the algorithm disclosed herein. In some implementations, the resizing module 1716 may downsize all images to a fixed size such as, for example, one megapixel.

A stretching reduction module 1718 may reduce stretching in an image by resizing the rectangle into which the image is stretched. Changes to an image by the stretching reduction module may be similar to those shown in FIG. 9.

The computing system(s) 108 may also include an image capture device 1720. For example, the image capture device may be implemented as a still camera (e.g., camera 104), a video camera, or the like. The image capture device 1720 may capture a plurality of images such as the images 202, 204, and 206. These images may later be combined to form the irregular-shaped input image such as, for example, the image 304 from FIG. 3. Thus, in some implementations the computing system(s) 108 may be combined in the same device the image capture device 1720 such as when implemented as a smart phone, a tablet computer, etc. that includes a camera.

The computing system(s) 108 may also include one or more conventional input/output device(s) 1722 such as a keyboard, a pointing device, a touchscreen, a microphone, a display, a speaker, a printer, and the like.

### EXAMPLES

The algorithm and techniques described herein create rectangled images faster than conventional image completion techniques. A C++ implementation of the algorithm discussed herein applied to a 10 megapixel panoramic image, with 18% of the pixels missing, on a computer with an Intel® Core i7 2.9 GHz single core CPU and 8 gigabyte (GB) memory rectangled the 10 megapixel image in 1.5 seconds. This is over ten times faster than the image completion tool “content-aware fill” in Adobe Photoshop® which took 19.1 seconds to process the same image.

Objective comparison of images shows that rectangular images created with the algorithm disclosed herein are more visually pleasing results than images rectangled using the “content-aware fill” in Adobe Photoshop® CS5. This comparison used 10,405 real full-view)(360°×180°) panoramic scenes with irregular boundaries. The panoramic scenes were separated into 80 categories such as indoor/outdoor scenes with various man-made/natural scenarios (e.g., bedroom, street, mountain, etc). Scenes were selected from each of the 80 categories to obtain a subset of 367 scenes.

To simulate taking a photograph with a camera, a simulated camera position of each image was slightly disturbed at random to simulate camera movement. Slightly altering the simulated position of the camera between photographs creates an image sequence that, when later stitched together, has irregular boundaries. For cylindrical projections 5×1 arrays of images were used, 3×1 arrays for perspective projections, and a 3×2 arrays for spherical projections. Adjacent images in the arrays had 30-50% overlapping area that was determined randomly. For each full-view scene, three different arrays were synthesized by stitched using the specified projection (i.e., cylindrical, perspective, or spherical). Thus, the dataset consisted of 1,101 (367×3) stitched images.

Ten users including five with computer graphics/vision backgrounds and five without such backgrounds were shown an input image, an image created by the global warping techniques disclosed herein, and an image created using content-aware fill. The users were allowed to zoom-in on the images. For each trio of images, users indicated their preference regarding which rectangling technique was more visually pleasing. Table 1 shows the percentage of user answers that indicated the global warping technique looked best, both techniques looked equally good, both techniques looked equally bad, or the image completion technique looked best.

TABLE 1

| | Cylindrical | Perspective | Spherical | Overall |
|---|---|---|---|---|
| Global Warping | 47.6% | 82.3% | 50.6% | 60.2% |
| Both Good | 44.9% | 11.3% | 39.1% | 31.8% |
| Both Bad | 3.6% | 5.2% | 6.4% | 5.1% |
| Image Completion | 3.9% | 1.2% | 3.9% | 3.0% |

The global warping technique disclosed herein was preferred across all of cylindrical, perspective, and spherical projections. The advantage of the global warping technique was particularly strong for perspective projections. Thus, the algorithm and techniques disclosed herein produce rectangular panoramic images that are qualitatively superior to a content-aware fill image completion technique.

### CONCLUSION

Although the subject matter has been described in language specific to structural features and/or methodological acts, it is to be understood that the subject matter defined in the appended claims is not necessarily limited to the specific features or acts described above. Rather, the specific features and acts are disclosed as example forms of implementing the claims.

1. A method comprising:
a) receiving a plurality of input images;
b) stitching the plurality of input images together to create a stitched image that has irregular boundaries;
c) expanding the stitched image to occupy a target rectangle to create a stretched rectangular image;
d) overlaying a mesh on the stretched rectangular image;
e) warping the mesh back to a shape of the stitched image to create a warped mesh;
f) overlaying the warped mesh on the stitched image;
g) creating, by a hardware processor, an output mesh by changing positions of vertexes of the warped mesh in a way that reduced the value of an energy function which includes a shape preservation function, a straight-line preservation function, and a boundary constraint function; and
h) warping the stitched image according to the output mesh.

2. The method of claim 1, wherein input images comprise at least three images of a panoramic scene.

3. The method of claim 1, wherein the stitching comprises at least one of a graph cuts algorithm or gradient-domain composting.

4. The method of claim 1, wherein the target rectangle comprises a bounding box that frames the stitched image.

5. The method of claim 1, wherein expanding the stitched image comprises:
selecting a connected sequence of missing pixels between an edge of the stitched image and the target rectangle;
adding a sequence of pixels within the stitched image that shifts a portion of the stitched image toward the inside edge of the target rectangle to fill all or some of the sequence of missing pixels; and
repeating the selecting and the adding until there are no missing pixels within the target rectangle.

6. The method of claim 1, wherein the mesh is a square mesh or a triangular mesh.

7. The method of claim 1, wherein the warping the mesh comprises repositioning grid vertexes of the mesh using a displacement field representing displacement that is created in the stitched image by expansion of the stitched image to occupy the target rectangle.

8. The method of claim 1, wherein the shape preservation function comprises a similarity transformation that reduces distortion in relatively more important regions of the stitched image while increasing distortion in relatively less important regions of the stitched image, importance of regions of the stitched image based at least in part on an importance map.

9. The method of claim 1, wherein the straight-line preserving function comprises:
detecting straight lines;
cutting the straight lines where the straight lines cross a line of the mesh to create a plurality of line segments;
calculating orientation vectors for the plurality of line segments;
dividing possible orientations into a number of bins;
grouping the line segments into the bins according to the respective orientation vectors;
calculating an average rotation angle of the line segments in the respective bins; and
rotating the line segments in a same bin by the average rotation angle.

10. The method of claim 1, wherein the boundary constraint function stretches vertexes on the outer boundary of the warped mesh to the target rectangle.

11. The method of claim 1, wherein the energy function comprises a weighted sum of the shape preservation function, the straight line preservation function, and the boundary constraint function.

12. The method of claim 1, wherein reducing the output of the energy function comprises an alternating algorithm that first fixes a target rotation angle of the straight line preserving function and solves for the output mesh then fixes the output mesh and solves for the target rotation angle.

13. The method of claim 1, further comprising:
following the warping the stitched image, calculating a mean vertical scaling factor and a mean horizontal scaling factor from changes in vertical and horizontal dimensions of cells of the output mesh compared to cells in the warped mesh;
scaling the vertical dimension of the target rectangle by a reciprocal of the mean vertical scaling factor and scaling the horizontal dimension of the target rectangle by a reciprocal of the mean horizontal scaling factor to create an updated target rectangle; and
repeating acts d-h using the updated target rectangle.

14. The method of claim 1, further comprising:
downsampling the stitched image from an original size to smaller size;
upsampling the output mesh from the smaller size to the original size to create an original size output mesh; and
warping the original size stitched image according to the original size output mesh.

15. The method of claim 1, further comprising:
introducing a transparent region at a concave boundary of the stitched image;
performing c-h with the transparent region treated the same as other pixels in the stitched image; and
filling the transparent region using image completion.

16. Computer storage media storing information that, when accessed by a computing device, instructs the computing devices to perform the acts of:
local warping an input image by seam carving to create a first rectangular image;
placing a mesh on the first rectangular image;
warping the mesh to a shape of the input image to create a warped mesh;
placing the warped mesh on the input image;
global warping of the input image by transforming the warped mesh to an output mesh to create a second rectangular image.

17. The media of claim 16, wherein the global warping comprises warping that preserves the appearance of shapes in the input image and preserves straight lines in the input image.

18. A system comprising;
one or more processing units;
a local warping module, in communication with the one or more processing units, configured to warp an irregular-shaped input image into a first rectangular image;
a mesh alignment module, in communication with the one or more processing units, configured to:
overlay a regular mesh on the rectangular image;
warp the mesh to a shape of the irregular-shaped input image making a warped mesh; and
overlay the warped mesh on the irregular-shaped input image;
a global warping module, in communication with the one or more processing units, configured to warp the irregular-shaped input image into a second rectangular image by transforming the warped mesh into an output mesh such that an output of an energy function describing locations of vertexes in the output mesh is reduced.

19. The system of claim 18, wherein the energy function preserves the appearance of shapes and the appearance of straight lines in the irregular-shaped input image.

20. The system of claim 18, further comprising an image capture device, coupled to the one or more processing units, configured to capture a plurality of images that are combined to form the irregular-shaped input image.
